(19) United States
(12) Patent Application Publication
(10) Pub. No.: US 2026/0154705 A1
(43) Pub. Date: Jun. 4, 2026

(54) Optimizing Hierarchical Queries for Digital Content Estimation

(71) Applicant: Google LLC, Mountain View, CA (US)

(72) Inventors: Badih Ghazi, Cupertino, CA (US); Matthew Dawson, Thousand Oak, CA (US); Pritish Kamath, Mountain View, CA (US); Kapil Kumar, San Jose, CA (US); Shanmugasundaram Ravikumar, Piedmont, CA (US); Bo Luan, Mountain View, CA (US); Pasin Manurangsi, Bangkok (TH); Nishanth Mundru, New York, NY (US); Harikesh Sasikumar Nair, Palo Alto, CA (US); Adam Sealfon, New York, NY (US); Shengyu Zhu, Cuoertino, CA (US)

(21) Appl. No.: 18/717,057

(22) PCT Filed: Nov. 27, 2023
(86) PCT No.: PCT/US2023/081082

§ 371 Date: Jun. 6, 2024

Related U.S. Application Data
(60) Provisional application No. 63/528,696, filed on Jul. 25, 2023.

(51) Int. Cl. G06Q 30/0242

(52) U.S. Cl. CPC G06Q 30/0246

(57) ABSTRACT

Aspects of the disclosure are directed to performing hierarchical queries based on summary reporting from an application programming interface (API) for digital content estimation. Performing the hierarchical queries can include denoising API outputs while ensuring consistency across different levels of a hierarchy. Performing the hierarchical queries can further include optimizing a privacy budget across different levels of the hierarchy.

### CROSS REFERENCE TO RELATED APPLICATIONS

The present application claims the benefit of the filing date of U.S. Provisional Application No. 63/528,696, filed on Jul. 25, 2023, entitled “Optimizing Hierarchical Queries for Digital Content Estimation,” the disclosure of which is hereby incorporated herein by reference.

### BACKGROUND

Third party cookies can be utilized in digital content management, such as conversion measurement. With third party cookies, an impression, such as a click or a view, on a publisher website or application can be joined to a conversion on a provider website or application to compute aggregate conversion reports, such as the number of conversions attributed to a subset of impressions, or to train bidding models for digital content. However, third-party cookie support from websites and applications has decreased. As such, managing digital content like measuring conversions of impressions has become more difficult and less accurate.

### BRIEF SUMMARY

Aspects of the disclosure are directed to performing queries based on summary reporting from an application programming interface (API) for digital content estimation, such as an attribution reporting API for conversion measurement. Performing the queries can include denoising API outputs while ensuring consistency across different levels of a hierarchy. Performing the queries can further include optimizing a privacy budget across different levels of the hierarchy.

An aspect of the disclosure provides for a method including: receiving, by one or more processors, a query requesting an estimate of hierarchical digital content reporting data; computing, by the one or more processors, a first estimate of counts for nodes of a hierarchy of the hierarchical digital content reporting data by processing the hierarchical digital content reporting data from one or more leaf nodes to a root node of the hierarchy; computing, by the one or more processors, a second estimate of counts for nodes of the hierarchy of the hierarchical digital content reporting data by processing, based on the first estimate, the hierarchical digital content reporting data from the root node to the one or more leaf nodes of the hierarchy; and outputting, by the one or more processors, the second estimate for responding to the query. Another aspect of the disclosure provides for a system including: one or more processors; and one or more storage devices coupled to the one or more processors and storing instructions that, when executed by the one or more processors, cause the one or more processors to perform operations according to the method. Yet another aspect of the disclosure provides for a non-transitory computer readable medium for storing instructions that, when executed by one or more processors, cause the one or more processors to perform operations according to the method.

In an example, the hierarchical digital content reporting data includes at least one of impression data, conversion data, attribution data, or histogram data. In another example, the hierarchical digital content reporting data corresponds to a dataset, wherein each node of the hierarchy corresponds to a subset of the rows of the dataset and conditioned on values of one or more attributes. In yet another example, each level of the hierarchy introduces a condition on a value of one or more additional attributes. In yet another example, one or more child nodes of a parent node of the hierarchy correspond to different values taken by one or more attributes in the dataset within the rows. In yet another example, one or more child nodes of a parent node of the hierarchy correspond to all possible values of one or more attributes. In yet another example, the second estimate includes an approximate number of rows of the dataset corresponding to each node having an attributed conversion.

In yet another example, computing the first estimate includes computing, for a node of the hierarchy, a convex combination of a direct estimate at that node and computing recursively computed estimates at each child node of that node. In yet another example, weights of the convex combination are inversely proportional to variance. In yet another example, computing the second estimate includes computing, for a node of the hierarchy, a difference between an estimate at that node and a sum of estimates of child nodes of that node and dividing the difference among the child nodes proportionally to a variance of the first estimate for each child node. In yet another example, computing the second estimate includes computing, for a node of the hierarchy, an estimate based on a parent of that node minus a sum of estimates of siblings of that node. In yet another example, computing the second estimate includes combining, for a node of the hierarchy, an estimate of that node with a sum of estimates of the children of that node.

In yet another example, the method further includes allocating, by the one or more processors, a privacy budget across levels of the hierarchy. In yet another example, allocating the privacy budget further includes iteratively selecting a level of the hierarchy that results in a lowest error and incrementally increasing the privacy budget at the selected level for each iteration.

### BRIEF DESCRIPTION OF THE DRAWINGS

FIG. 1 depicts a block diagram of an example hierarchy for digital content according to aspects of the disclosure.

FIG. 2 depicts a block diagram of an example construction of histogram contributions according to aspects of the disclosure.

FIG. 3 depicts an example table of a dataset of post-attribution and pre-aggregation for a summary report according to aspects of the disclosure.

FIG. 4 depicts a block diagram of an example hierarchical query estimation system according to aspects of the disclosure.

FIG. 5 depicts a block diagram of an example environment for implementing a hierarchical query estimation system according to aspects of the disclosure.

FIG. 6 depicts graphs evaluating an example hierarchical query estimation system on a first dataset for digital content conversion according to aspects of the disclosure.

FIG. 7 depicts graphs evaluating an example hierarchical query estimation system on a second dataset for digital content conversion according to aspects of the disclosure.

FIG. 8 depicts a flow diagram of an example process for processing hierarchical queries according to aspects of the disclosure.

### DETAILED DESCRIPTION

The technology generally relates to processing hierarchical queries based on summary reporting associated with digital content management, such as conversion measurement for online advertising. A query can include a request to count a number of conversions attributed to impressions where some features of the conversions and the impression are restricted to certain predetermined values. Hierarchical queries can refer to a request to estimate the number of conversions attributed to impressions where the features are restricted according to nested conditions.

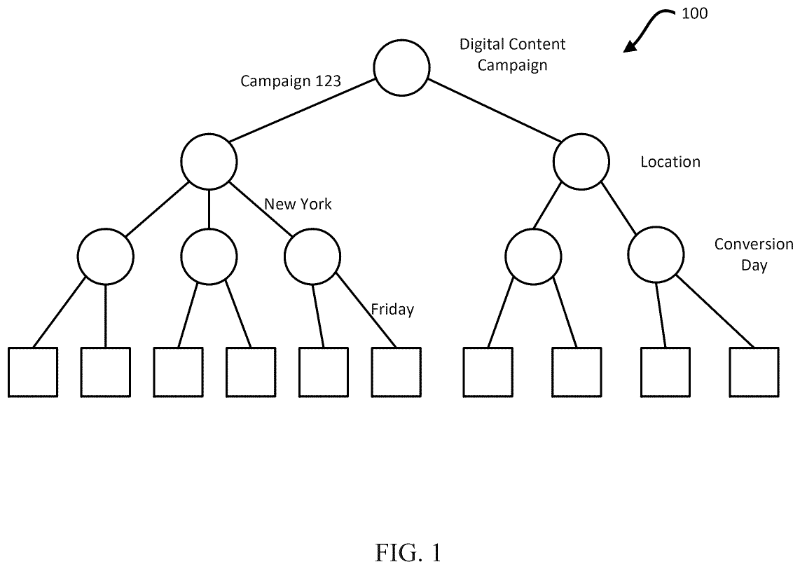

FIG. 1 depicts a block diagram of an example hierarchy 100. The hierarchical query can include a request to estimate the number of conversions attributed to different levels and/or nodes of the hierarchy. For example, the hierarchical query can include a request to estimate the number of conversions attributed to the root node or first level, e.g., a total number of conversions, estimate the number of conversion attributed to one or more nodes of the second level, and/or estimate the number of conversions attributed to one or more nodes of one or more additional levels, e.g., a third level or fourth level. The levels of the hierarchy can represent features of a digital content campaign. For example, the root node or first level can represent the campaign, nodes of the second level can represent locations of the campaign, and nodes of the third level can represent time periods when the campaign occurred. A hierarchical query can include a request to estimate the number of conversions attributed to the digital content campaign, conversions attributed to a New York location of the digital convent campaign, and/or conversions attributed to a Friday time period of the digital content campaign.

The estimates can be obtained using summary reports received via an application programming interface (API), such as an attribution reporting API. The API can implement one or more mechanisms for limiting data leakage, such as bounding contributions to output reports of conversions attributed to each impression and/or noise injection for differential privacy. Processing the hierarchical query can include denoising the estimates for different nodes returned by the API and determining that the estimates are consistent with the hierarchical structure. Processing the hierarchical query can further include optimizing allocation of a privacy budget across different levels of the hierarchy.

Differential privacy can refer to sharing information about a dataset by describing patterns within the dataset while withholding more specific information in the dataset. n can be a number of rows in the dataset and X can be an arbitrary set representing a domain of values for each row. The dataset can include known columns, e.g., known attributes, and unknown columns, e.g., unknown attributes. Each unknown column or attribute can be a set of possible values. For example, for ε≥0, an algorithm A is ε-DP if for every pair X, X′ of datasets that differ on the unknown attributes of one row, and for each possible output o, then Pr [A(X)=o]≤e^{ε}. Pr [A(X′)=o]. As another example, if A is an algorithm that runs k algorithms A₁, . . . , Aₖ on the same dataset where Aᵢ is εᵢ-DP with εᵢ≥0 for each i∈[k], then A can be

$$( {Σ}_{i = 1}^{k} {ε}_{i} ) - DP .$$

As yet another example, for ε>0 and R, R′ being any two datasets, if A: Xⁿ→R is an ε-DP algorithm and ƒ:R→R′ is a randomized mapping, then (ƒ·A):Xⁿ→R′ can be ε-DP.

Discrete Laplace mechanisms can be implemented for differential privacy. For any dataset X and d-dimensional function ƒ:Xⁿ→R^{d}, L₁-sensitivity can be Δ₁f:=max_{X,X}, ∥ƒ(X)−ƒ(X′)∥₁ where X and X′ are two datasets that differ on the unknown attributes of a single row. A discrete Laplace distribution centered at 0 and with parameter a>0, denoted DLap(a), can be the distribution whose probability mass function at integer

$$k , \frac{{e}^{a} - 1}{{e}^{a} + 1} \cdot {e}^{- a \vert k \vert} .$$

A d-dimensional discrete Laplace mechanism with parameter a applied to a function ƒ: Xⁿ→Z^{d}, on input a dataset X∈Xⁿ, can return ƒ(X)+Z where Z is a d-dimensional noise random variable whose can be sampled independently and identically distributed (i.i.d.) from DLap(a). For every ε>0, the d-dimensional discrete Laplace mechanism with parameter

$$a \leq \frac{ε}{{Δ}_{1} f}$$

### can be ε-DP.

The summary reports or aggregated reports received from the API can include impression registration, conversion registration, attribution, and/or histogram contribution generation. Impression or source registration can refer to a mechanism for registering an impression, such as a click or view, on a publisher website or application. During registration, impression-side aggregation keys can be specified, such as keys corresponding to a campaign or geolocation. Conversion or trigger registration can refer to a mechanism for registering a conversion on a provider website or application. During conversion, conversion-side key pieces can be specified along with aggregable values corresponding to each setting of the impression-side aggregation keys. For example, a conversion-side key piece can capture a conversion type or a discretization of a conversion timestamp. A combined aggregation key can be a concatenation of the impression-side aggregation key and the conversion-side key piece. The aggregable value can be an integer between 1 and the L₁ parameter of the API. Attribution can refer to last-touch attribution where the conversion is attributed to the last unexpired registered impression, as an example.

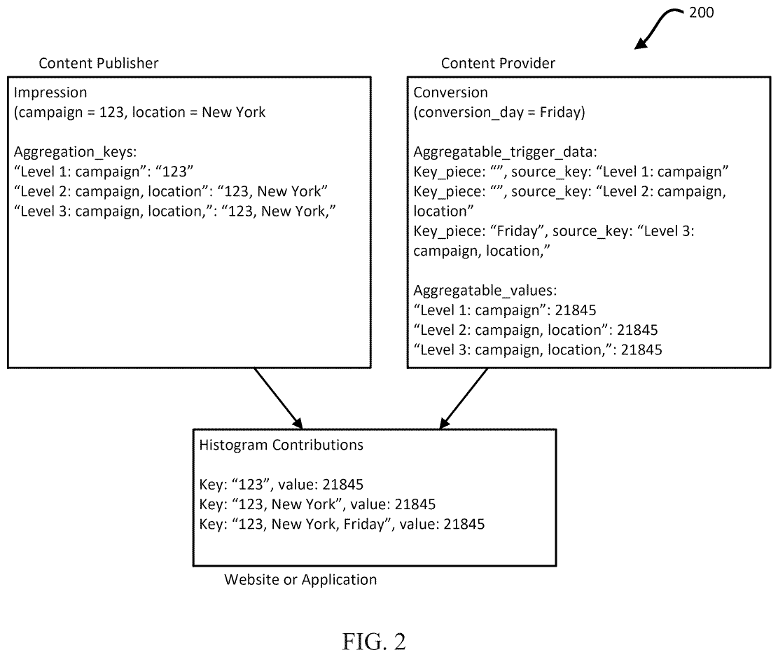

Histogram contribution generation can refer to a sum of contributions across all aggregable reports generated by different conversions attributed to the same impression. FIG. 2 depicts a block diagram of an example construction of histogram contributions 200. In this example, the conversion key piece depends only on conversion information, such as the conversion day. In other examples, the conversion key piece can depend on both impression and conversion information, such as a discretization of the difference between impression time and conversion time. Dependence of the conversion key piece on both impression and conversion information can be implemented using filters.

For a query, a set of histogram keys can be requested. The set of keys that are queried can be a set of a Cartesian product of all known values of the impression-side features with a set of all possible values of the conversion-side features. The aggregable reports can be combined to produce a summary report by applying the discrete Laplace mechanism with a parameter

$$\frac{ε}{{L}_{1}}$$

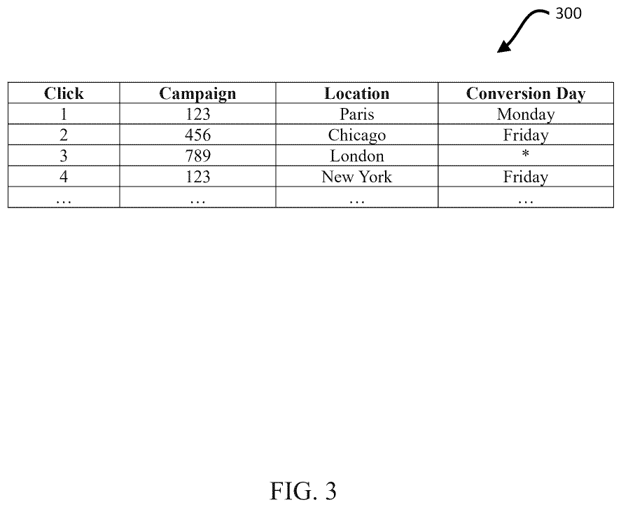

to the requested aggregation keys. The summary report can satisfy ε-DP, where each row of the dataset corresponds to an impression and its attributed conversions, if any, and the known columns are the attributes that only depend on impression information, such as campaign and/or location. FIG. 3 depicts an example table of a dataset of post-attribution and pre-aggregation for a summary report. The * in the conversion-related field can indicate that the click corresponding to that row did not get an attributed conversion.

In the hierarchical aggregation setting, each node of a hierarchy tree can correspond to an aggregation key. The level of the node in the hierarchy can be implicitly specified in the impression-side aggregation key and/or in the conversion-side key piece.

For estimating conversion counts, the aggregable value can be set to increment the count by +1. Since the scale of the noise injected in summary reports can be

$$\frac{{L}_{1}}{ε} ,$$

accuracy can be improved by setting the contribution of an increment to +L₁ and then scaling down the value received from the aggregation service by L₁. If the L₁ contribution is divided across multiple keys, the contribution of each increment can be scaled down accordingly. For example, in FIG. 2, since each impression affects 3 keys, the contribution can be set to

$$\frac{{L}_{1}}{3} .$$

For hierarchical query estimation, given a dataset X, each node of a hierarchy tree can correspond to a subset of the rows of X, conditioned on the values of some of the attributes. Each level of the hierarchy tree can introduce a conditioning on the value of a new attribute. For known attributes, the child nodes of a node can correspond to the different values taken by that attribute in X within the rows. For unknown attributes, the child nodes can correspond to all possible values for that attribute, whether or not they actually occur in the dataset. Hierarchical query estimation can determine an approximate number of data rows corresponding to each node that have an attributed conversion.

As an example, error measure for the hierarchical query estimation can be defined as root mean square relative error at a threshold. For a count c≥0 and its randomized estimate ĉ∈R, the root mean squared relative error at threshold t when estimating c by ĉ can be defined as

$$R M S R {E}_{τ} ( c , \hat{c} ) = \sqrt{E [ {( \frac{\vert \hat{c} - c \vert}{( τ , c )} )}^{2} ]} ,$$

where the expectation is over the randomness of ĉ.

Referring back to FIG. 1, given count estimates, such as the number of conversions, at each node in the hierarchy tree, then each conversion can contribute to the count for multiple nodes. For example, a conversion for a digital content campaign 123 that occurs on a Friday in New York can contribute to the 6^{th} leaf from the left, but also contribute to each of its ancestor nodes. This imposes relationships among the counts at various nodes. If the only geolocations with conversions attributed to the digital content campaign on Friday are New York and Chicago, then the total number of such conversions may equal the sum of the number of such conversions in each of the two locations. Therefore, the count for any node may equal the sum of the counts for its children. This property can be referred to as consistency.

For a hierarchy tree T with levels L₀, . . . , L_{d}, with Lᵢ being the set of nodes at level i, and estimators ĉᵥ of the counts cᵥ at each node v, the tree error can be defined as

$$R M S R {E}_{τ} ( T ) = \sqrt{\frac{1}{d + 1} {\sum }_{i = 0}^{d} ( \frac{1}{\vert {L}_{i} \vert} {\sum }_{v ∈ {L}_{i}} R M S R {{E}_{τ} ( c , \hat{c} )}^{2} )} .$$

Hierarchical query processing can estimate the counts of every node while reducing possible tree error and having consistent estimates.

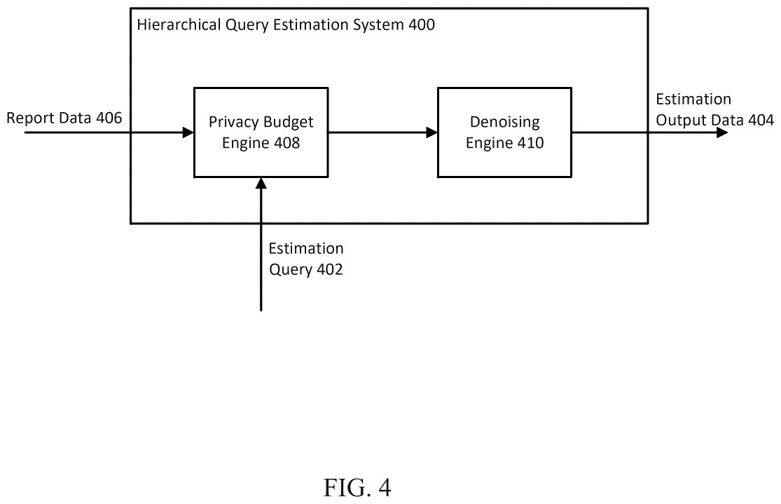

FIG. 4 depicts a block diagram of an example hierarchical query estimation system 400. The hierarchical query estimation system 400 may be part of a remote system in communication with one or more client or server devices via a network. The remote system may be a single computer, multiple computers, or a distributed system like a cloud environment. The remote system may include computing resources, such as data processing hardware, and storage resources, such as memory hardware. A data store, such as a remote storage device, may be overlain on the storage resources to allow scalable use of the storage resources by one or more of the clients, such as the client or server devices, or the computing resources. The data store can be configured to store a plurality of data blocks within one or more tables, such as a cloud database, that each include a plurality of rows and columns. The data store may store any number of tables with any number of rows and columns.

The hierarchical query estimation system 400 can be configured to receive an estimation query 402, such as from a client device via the network. The client device may correspond to any computing device, such as a desktop workstation, a laptop workstation, or a mobile device, such as a smartphone. The client device can include computing resources and storage resources. The estimation query 402 may be natural language or structured query language (SQL). The estimation query 402 can request one or more estimations associated with digital content to generate estimation output data 404 based on report data 406. For example, the estimation query 402 can include a request to count a number of conversions attributed to impressions, where features of the conversion are restricted based on nested conditions. The estimated number of conversions can be output as the estimation output data 404.

The report data 406 can include data associated with one or more summary reports, which can include impression data, conversion data, attribution data, and/or histogram data. The summary reports can reflect a hierarchy in a dataset, where each node of the hierarchy can correspond to a subset of the rows of the datasets and conditioned on values of one or more attributes. Each level of the hierarchy can introduce a condition on the value of a new attribute. For known attributes, the child nodes of a node can correspond to the different values taken by that attribute in the dataset within the rows. For unknown attributes, the child nodes can correspond to all possible values for that attribute, whether or not they actually occur in the dataset.

The hierarchical query estimation system 400 can estimate and return the estimation output data 404 to the client device via the network as a query response. The estimation output data 404 can include an approximate number of data rows corresponding to each node that has an attributed conversion.

The hierarchical query estimation system 400 can include a privacy budget engine 408 and a denoising engine 410. The privacy budget engine 408 and the denoising engine 410 can be implemented as one or more computer programs, specially configured electronic circuitry, or any combination thereof.

The privacy budget engine 408 can be configured to allocate a privacy budget across levels of the hierarchy. Given counts c, the privacy budget engine 408 can optimize privacy budget allocation iteratively, such as a greedy budget allocation or other derivative-free optimization based allocation, and/or a gradient-based allocation. The counts can refer to true count data, simulated data, historical data, and/or noisy historical data. With k number of phases, such as k=20, corresponding to the granularity of the allocation, the privacy budget engine 408 can allocate 0 or an infinitesimal privacy budget to each level of the hierarchy and divide the remaining privacy budget into k units of size

$$\frac{ε}{k} .$$

In each of the k phases, the privacy budget engine 408 can select the level of the hierarchy that would result in the lowest error, e.g., RMSRE_{τ}(T), when using ε/k additional privacy budget and can increase the privacy budget of that level by ε/k. The privacy budget engine 408 can estimate the error, e.g., RMSRE_{τ}(T), empirically or directly using variance of estimates based on the counts, such as the true count data, simulated data, historical data, and/or noisy historical data.

The denoising engine 410 can be configured to estimate counts for nodes of a hierarchy. The denoising engine 410 can obtain a first estimate of only the counts of leaf nodes of the hierarchy and inferring the count of each non-leaf by adding the counts of its leaf descendants. Leaf nodes may refer to nodes without children, e.g., nodes at the bottom of a hierarchy. Since the count of any node can equal the sum of the counts of its children, the denoising engine 410 can obtain a second independent estimate of the count of any non-leaf node by summing the estimates of its children. The denoising engine 410 can combine the two estimates to obtain a single estimate that preserves differential privacy while lowering variance and improving accuracy. The denoising engine 410 can estimate the counts of each node using linear regression, such as computing a least-squares solution.

The denoising engine 410 can perform two linear processes on the hierarchy. The first process can proceed from the leaves to the root of the hierarchy. For example, the denoising engine 410 can, for each node, compute an optimal convex combination of a direct estimate at that node and recursively computed estimates at each child of the node. The weights of the convex combination can be inversely proportional to the variances. The first process can reduce the error of the estimate at each node. The first process can be referred to as a lower estimate of each node. The second process can proceed from the root to the leaves of the hierarchy. The second process can achieve consistency and further reduce error of the estimate at each node. For example, the denoising engine 410 can, for each node, compute a difference between the estimate at that node and the sum of the estimates of children of that node and divide the difference among the children proportionally to a variance of the first estimate of each child node. For instance, if the variance is equal, then the difference is divided equally among the children. As another example, the denoising engine 410 can compute an upper estimate of each node based on the upper estimate of the parent of that node minus the sum of the lower estimates of the siblings of that node. Based on the upper and lower estimates of each node, the denoising engine 410 can combine that upper estimate of a node with the sum of the lower estimates of the children of that node, such as by performing a convex combination with weights inversely proportional to variances. This allows for computing variances of the estimates and not just the estimates themselves.

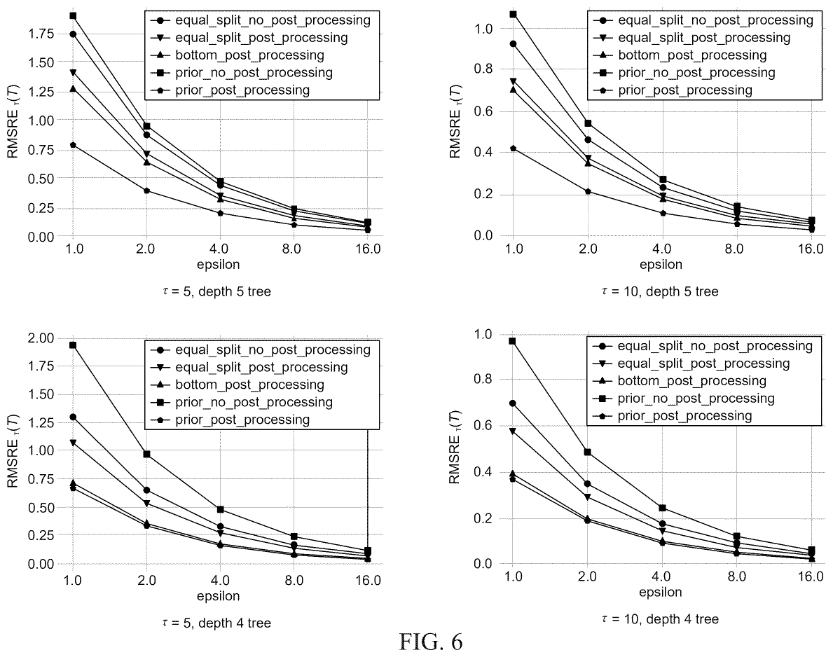

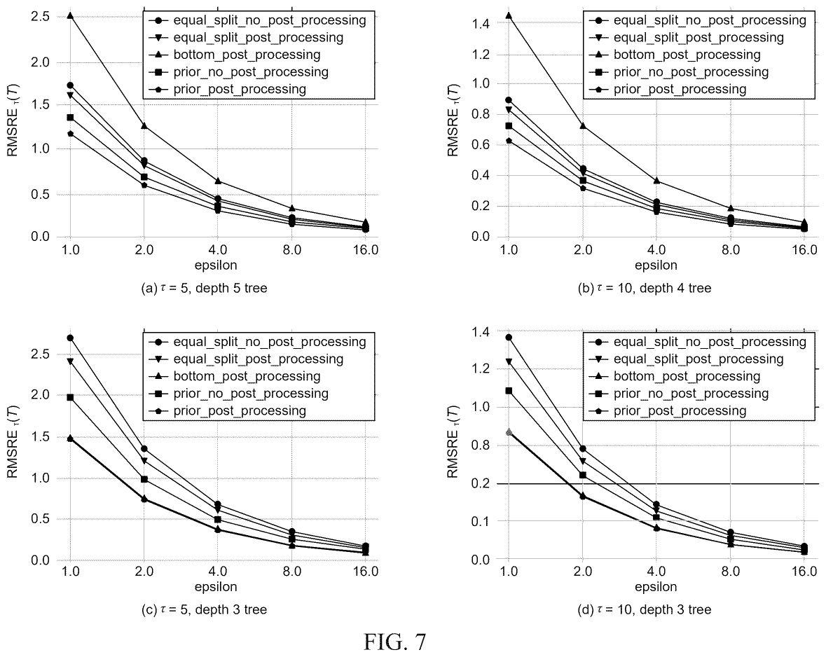

The denoising engine 410, or more generally the hierarchical query estimation system 400, can estimate counts while reducing errors, providing consistency, and preserving weighted root to leaf summation. For example, estimate (yᵥ)_{v∈T} can minimize RMSRE_{τ}((cᵥ)_{v∈T},(yᵥ)_{v∈T}), since for every non-leaf node v, yᵥ can equal Σ_{u∈child(v)}yᵤ and for every leaf v,

$${\sum }_{u ∈ anc ( v )} \frac{{x}_{u}}{{var}_{u}} can equal {\sum }_{u ∈ anc ( v )} \frac{{y}_{u}}{{var}_{u}} ,$$

where anc(v) denotes the nodes on the path from leaf v to root r, inclusive. This can allow for improved performance of hierarchical query estimation, to be described further with respect to the graphs in FIGS. 6-7.

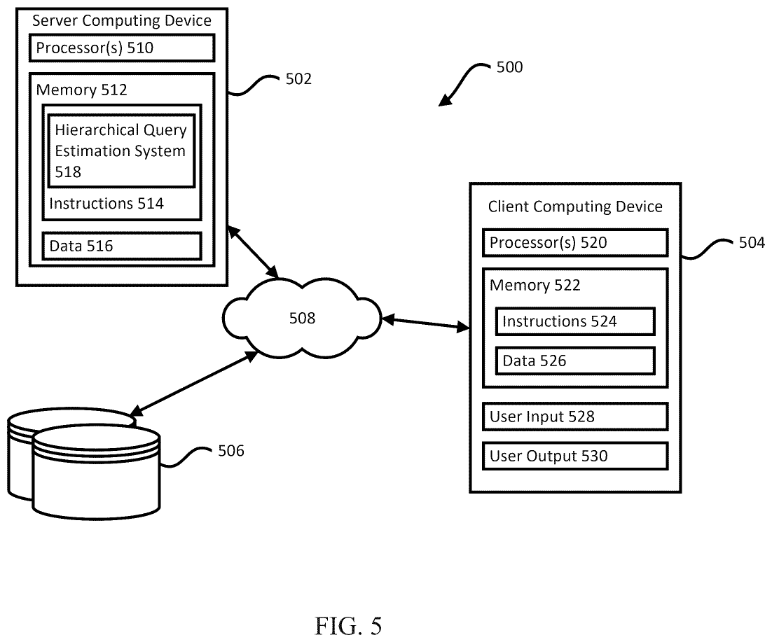

FIG. 5 depicts a block diagram of an example environment 500 for implementing a hierarchical query estimation system 518. The hierarchical query estimation system 518 can be implemented on one or more devices having one or more processors in one or more locations, such as in server computing device 502. Client computing device 504 and the server computing device 502 can be communicatively coupled to one or more storage devices 506 over a network 508. The storage devices 506 can be a combination of volatile and non-volatile memory and can be at the same or different physical locations than the computing devices 502, 504. For example, the storage devices 506 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 502 can include one or more processors 510 and memory 512. The memory 512 can store information accessible by the processors 510, including instructions 514 that can be executed by the processors 510. The memory 512 can also include data 516 that can be retrieved, manipulated, or stored by the processors 510. The memory 512 can be a type of non-transitory computer readable medium capable of storing information accessible by the processors 510, such as volatile and non-volatile memory. The processors 510 can include one or more central processing units (CPUs), graphic processing units (GPUs), field-programmable gate arrays (FPGAs), and/or application-specific integrated circuits (ASICs), such as tensor processing units (TPUs).

The instructions 514 can include one or more instructions that, when executed by the processors 510, cause the one or more processors to perform actions defined by the instructions 514. The instructions 514 can be stored in object code format for direct processing by the processors 510, or in other formats including interpretable scripts or collections of independent source code modules that are interpreted on demand or compiled in advance. The instructions 514 can include instructions for implementing a hierarchical query estimation system 518, which can correspond to the hierarchical query estimation system 400 of FIG. 4. The hierarchical query estimation system 518 can be executed using the processors 510, and/or using other processors remotely located from the server computing device 502.

The data 516 can be retrieved, stored, or modified by the processors 510 in accordance with the instructions 514. The data 516 can be stored in computer registers, in a relational or non-relational database as a table having a plurality of different fields and records, or as JSON, YAML, proto, or XML documents. The data 516 can also be formatted in a computer-readable format such as, but not limited to, binary values, ASCII, or Unicode. Moreover, the data 516 can include information sufficient to identify relevant information, such as numbers, descriptive text, proprietary codes, pointers, references to data stored in other memories, including other network locations, or information that is used by a function to calculate relevant data.

The client computing device 504 can also be configured similarly to the server computing device 502, with one or more processors 520, memory 522, instructions 524, and data 526. The client computing device 504 can also include a user input 528 and a user output 530. The user input 528 can include any appropriate mechanism or technique for receiving input from a user, such as keyboard, mouse, mechanical actuators, soft actuators, touchscreens, microphones, and sensors.

The server computing device 502 can be configured to transmit data to the client computing device 504, and the client computing device 504 can be configured to display at least a portion of the received data on a display implemented as part of the user output 530. The user output 530 can also be used for displaying an interface between the client computing device 504 and the server computing device 502. The user output 530 can alternatively or additionally include one or more speakers, transducers or other audio outputs, a haptic interface or other tactile feedback that provides non-visual and non-audible information to the platform user of the client computing device 504.

Although FIG. 5 illustrates the processors 510, 520 and the memories 512, 522 as being within the computing devices 502, 504, components described herein can include multiple processors and memories that can operate in different physical locations and not within the same computing device. For example, some of the instructions 514, 524 and the data 516, 526 can be stored on a removable SD card and others within a read-only computer chip. Some or all of the instructions and data can be stored in a location physically remote from, yet still accessible by, the processors 510, 520. Similarly, the processors 510, 520 can include a collection of processors that can perform concurrent and/or sequential operation. The computing devices 502, 504 can each include one or more internal clocks providing timing information, which can be used for time measurement for operations and programs run by the computing devices 502, 504.

The server computing device 502 can be configured to receive requests to process data from the client computing device 504. For example, the environment 500 can be part of a computing platform configured to provide a variety of services to users, through various user interfaces and/or application programming interfaces (APIs) exposing the platform services. The variety of services can include performing hierarchical query estimations. The client computing device 504 can transmit a query requesting a hierarchical estimation based on data from summary reports. The hierarchical query estimation system 518 can receive the query and data, and in response, generate estimation output data.

The devices 502, 504 can be capable of direct and indirect communication over the network 508. For example, using a network socket, the client computing device 504 can connect to a service through an Internet protocol. The devices 502, 504 can set up listening sockets that may accept an initiating connection for sending and receiving information. The network 508 itself can include various configurations and protocols including the Internet, World Wide Web, intranets, virtual private networks, wide area networks, local networks, and private networks using communication protocols proprietary to one or more companies. The network 508 can support a variety of short- and long-range connections. The short- and long-range connections may be made over different bandwidths, such as 2.402 GHZ to 2.480 GHz, commonly associated with the Bluetooth® standard, 2.4 GHZ and 5 GHZ, commonly associated with the Wi-Fi® communication protocol; or with a variety of communication standards, such as the LTE® standard for wireless broadband communication. The network 508, in addition or alternatively, can also support wired connections between the devices 502, 504, including over various types of Ethernet connection.

Although a single server computing device 502 and client computing device 504 are shown in FIG. 5, it is understood that the aspects of the disclosure can be implemented according to a variety of different configurations and quantities of computing devices, including in paradigms for sequential or parallel processing, or over a distributed network of multiple devices.

FIG. 6 depicts graphs evaluating an example hierarchical query estimation system on a first dataset for digital content conversion. The first dataset can correspond to a Criteo Sponsored Search Conversion Log (CSSCL) Dataset. This dataset includes 15,995,634 points obtained from a sample of 90-day logs of live traffic from Criteo Predictive Search. Each point contains information on an action, such as a click on an ad, and a potential subsequent conversion, such as purchase of a corresponding product, within a 30-day attribution window. FIG. 7 depicts graphs evaluating an example hierarchical query estimation system on a second dataset for digital content conversion. The second dataset can correspond to a Criteo Attribution Modeling for Bidding (CAMB) dataset. This dataset includes 16,468,027 impressions in a sample of 30 days of Criteo live traffic data.

The graphs in FIGS. 6-7 plot RMSRE_{τ} versus ε for various procedures evaluated on 45 days of data. The procedures include equal privacy budget split across levels with no post-processing; equal privacy budget split across levels with post-processing; all privacy budget on leaves with post-processing; prior-based optimized privacy budget split across levels with no post-processing; and prior-based optimized privacy budget split across levels with post-processing. As shown in the graphs in FIGS. 6-7, prior-based privacy budgeting with post-processing as performed by a hierarchical query estimation system equals or outperforms the other approaches in each setting, which can be attributed to the two linear processes performed on the hierarchy, where the first process proceeds from the leaves to the root and the second process proceeds from the root to the leaves.

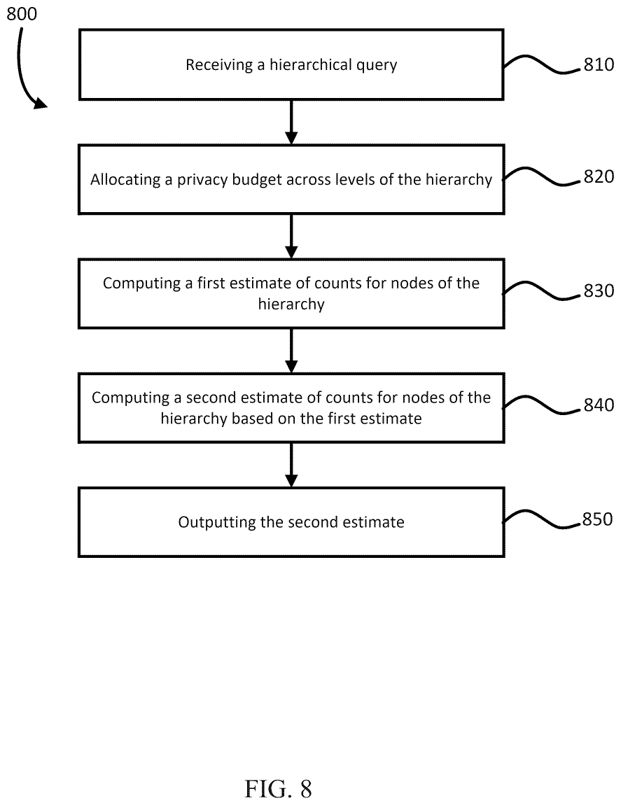

FIG. 8 depicts a flow diagram of an example process 800 for processing hierarchical queries. The example process 800 can be performed on a system of one or more processors in one or more locations, such as the hierarchical query estimation system 400 as depicted in FIG. 4.

As shown in block 810, the hierarchical query estimation system can receive a query requesting an estimate of hierarchical digital content reporting data. The hierarchical digital content reporting data can include impression data, conversion data, attribution data, and/or histogram data. The hierarchical digital content reporting data can correspond to a dataset where each node of a hierarchy can correspond to a subset of the rows of the dataset and conditioned on values of one or more attributes. Each level of the hierarchy can introduce a condition on a value of an additional attribute. One or more child nodes of a parent node of the hierarchy can correspond to different values taken by an attribute in the dataset within the rows. In addition, or alternatively, one or more child nodes of a parent node of the hierarchy can correspond to all possible values of an attribute.

As shown in block 820, the hierarchical query estimation system can allocate a privacy budget across levels of the hierarchy. Allocating the privacy budget can include iteratively selecting a level of the hierarchy that results in a lowest error. Allocating the privacy budget can further include incrementally increasing the privacy budget at the selected level for each iteration.

As shown in block 830, the hierarchical query estimation system can compute a first estimate of counts for nodes of the hierarchy of the hierarchical digital content reporting data by processing the hierarchical digital content reporting data from one or more leaf nodes to a root node of the hierarchy. Computing the first estimate can include computing, for one or more nodes of the hierarchy, a convex combination of a direct estimate at each of the one or more nodes. Computing the first estimate can further include computing recursively computed estimates at each child node of each of the one or more nodes. Weights of the convex combination can be inversely proportional to variance.

As shown in block 840, the hierarchical query estimation system can compute a second estimate of counts for nodes of the hierarchy of the hierarchical digital content reporting data based on the first estimate by processing the hierarchical digital content reporting data from the root nodes to the one or more leaf nodes of the hierarchy. Computing the second estimate can include computing, for one or more nodes of the hierarchy, a difference between an estimate at each of the one or more nodes of the first or second estimate and a sum of estimates of child nodes of each of the one or more nodes of the first estimate. Computing the second estimate can further include dividing the difference among the child nodes proportionally to a variance of the first estimate of each child node.

As shown in block 850, the hierarchical query estimation system can output the second estimate for responding to the query.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
receiving, by one or more processors, a query requesting an estimate of hierarchical digital content reporting data;
computing, by the one or more processors, a first estimate of counts for nodes of a hierarchy of the hierarchical digital content reporting data by processing the hierarchical digital content reporting data from one or more leaf nodes to a root node of the hierarchy;
computing, by the one or more processors, a second estimate of counts for nodes of the hierarchy of the hierarchical digital content reporting data by processing, based on the first estimate, the hierarchical digital content reporting data from the root node to the one or more leaf nodes of the hierarchy; and
outputting, by the one or more processors, the second estimate for responding to the query.

2. The method of claim 1, wherein the hierarchical digital content reporting data comprises at least one of impression data, conversion data, attribution data, or histogram data.

3. The method of claim 1, wherein the hierarchical digital content reporting data corresponds to a dataset, wherein each node of the hierarchy corresponds to a subset of the rows of the dataset and conditioned on values of one or more attributes.

4. The method of claim 3, wherein each level of the hierarchy introduces a condition on a value of one or more additional attributes.

5. The method of claim 3, wherein one or more child nodes of a parent node of the hierarchy correspond to different values taken by one or more attributes in the dataset within the rows.

6. The method of claim 3, wherein one or more child nodes of a parent node of the hierarchy correspond to all possible values of one or more attributes.

7. The method of claim 3, wherein the second estimate comprises an approximate number of rows of the dataset corresponding to each node having an attributed conversion.

8. The method of claim 1, wherein computing the first estimate comprises computing, for a node of the hierarchy, a convex combination of a direct estimate at that node and computing recursively computed estimates at each child node of that node.

9. The method of claim 8, wherein weights of the convex combination are inversely proportional to variance.

10. The method of claim 1, wherein computing the second estimate comprises computing, for a node of the hierarchy, a difference between an estimate at that node and a sum of estimates of child nodes of that node and dividing the difference among the child nodes proportional to a variance of the first estimate of each child node.

11. The method of claim 1, wherein computing the second estimate comprises computing, for a node of the hierarchy, an estimate based on a parent of that node minus a sum of estimates of siblings of that node.

12. The method of claim 1, wherein computing the second estimate comprises combining, for a node of the hierarchy, an estimate of that node with a sum of estimates of the children of that node.

13. The method of claim 1, further comprising allocating, by the one or more processors, a privacy budget across levels of the hierarchy.

14. The method of claim 13, wherein allocating the privacy budget further comprises iteratively selecting a level of the hierarchy that results in a lowest error and incrementally increasing the privacy budget at the selected level for each iteration.

15. A system comprising:
one or more processors; and
one or more storage devices coupled to the one or more processors and storing instructions that, when executed by the one or more processors, cause the one or more processors to perform operations comprising:
receiving a query requesting an estimate of hierarchical digital content reporting data;
computing a first estimate of counts for nodes of a hierarchy of the hierarchical digital content reporting data by processing the hierarchical digital content reporting data from one or more leaf nodes to a root node of the hierarchy;
computing a second estimate of counts for nodes of the hierarchy of the hierarchical digital content reporting data by processing, based on the first estimate, the hierarchical digital content reporting data from the root node to the one or more leaf nodes of the hierarchy; and
outputting the second estimate for responding to the query.

16. The system of claim 15, wherein the hierarchical digital content reporting data corresponds to a dataset, wherein each node of the hierarchy corresponds to a subset of the rows of the dataset and conditioned on values of one or more attributes and the second estimate comprises an approximate number of rows of the dataset corresponding to each node having an attributed conversion.

17. The system of claim 15, wherein computing the first estimate comprises computing, for a node of the hierarchy, a convex combination of a direct estimate at that node and computing recursively computed estimates at each child node of that node.

18. The system of claim 15, wherein computing the second estimate comprises computing, for a node of the hierarchy, a difference between an estimate at that node and a sum of estimates of child nodes of that node and dividing the difference among the child nodes proportional to a variance of the first estimate of each child node.

19. The system of claim 15, wherein computing the second estimate comprises:
computing, for a node of the hierarchy, an estimate based on a parent of that node minus a sum of estimates of siblings of that node; and
combining an estimate of that node with a sum of estimates of the children of that node.

20. A non-transitory computer readable medium for storing instructions that, when executed by one or more processors, cause the one or more processors to perform operations comprising:
receiving a query requesting an estimate of hierarchical digital content reporting data;
computing a first estimate of counts for nodes of a hierarchy of the hierarchical digital content reporting data by processing the hierarchical digital content reporting data from one or more leaf nodes to a root node of the hierarchy;
computing a second estimate of counts for nodes of the hierarchy of the hierarchical digital content reporting data by processing, based on the first estimate, the hierarchical digital content reporting data from the root node to the one or more leaf nodes of the hierarchy; and
outputting the second estimate for responding to the query.
